(19) United States
(12) Patent Application Publication
(10) Pub. No.: US 2006/0107509 A1
(43) Pub. Date: May 25, 2006

(54) Method of sealing threaded connections

(76) Inventors: Eugene J. Mannella, Richmond, TX (US); Larry Cobb, Kingwood, TX (US)

Correspondence Address: JOHN A MOLNAR JR;PARKER-HANNIFIN CORPORATION, 6035 PARKLAND BOULEVARD, CLEVELAND, OH, 44124-4141, US

(21) Appl. No.: 11/119,112

(22) Filed: Apr. 29, 2005

Related U.S. Application Data
(60) Provisional application No. 60/630,439, filed on Nov. 23, 2004.

(51) Int. Cl. B23Q 17/00; B23P 25/00

(52) U.S. Cl. 29/407.1; 29/458; 29/407.09; 29/890.14

(57) ABSTRACT

Method of sealing one or more threaded connections between ends of a pair of tubular members configured to be rotatably threadably engageable. One of the members as an externally-threaded portion, with the other one having an internally-threaded portion. One of the threaded portions has a radial groove formed therein which is configured to receive a seal ring for sealing the connection. The groove of the one portion defines a void with the other portion, with the seal ring being compressed into the void by the engagement of the threaded ends of the members. The method involves determining a deformed axial cross-sectional geometries of the ends, mathematically revolving the deformed axial cross-sectional geometries to generate a corresponding solid of revolution, calculating the volume of the void by subtracting the open of the solid volumes from the other, and sizing the seal ring to overfill the void by a specified amount.

### CROSS-REFERENCE TO RELATED CASE

The present application claims the benefit of the filing date of U.S. Provisional Application Ser. No. 60/630,439, Nov. 23, 2004, the disclosure of which is expressly incorporated herein by reference.

### BACKGROUND OF THE INVENTION

The present invention relates broadly to a method of sealing connections between threaded pipes and other tubular sections, and more particularly to such a method which includes a precision calculation of the void volume for the seal ring retaining grooves provided in one or both of the sections for the sealing of the connection.

The oil and gas industry has devised various ways to extract crude oil and other subsurface hydrocarbons to support the world's energy needs. One method uses a process called steam injection wherein a series of carefully spaced wells are drilled into a producing formation. Some of these wells, called “injectors,” are used to inject high pressure steam into the formation. The hot, pressurized steam force the hydrocarbons to the other wells, called “producers,” for recovery. Steam injection is most often employed in fields which are commercially marginal and which are particularly sensitive to recovery costs. While there are a number of casing and tubing connections in use, many require expensive specialty threads and/or connections with metal-to-metal seals.

Recently, oil and gas exploration has expanded into new frontiers, such as deepwater drilling in water depths greater than 5,000 feet (1500 m). Wells targeting oil and gas reservoirs found deep below the sea floor are called HPHT (high-pressure, high temperature) wells. These wells offer new challenges and many operators desire tubular connections with multiple sealing mechanisms.

As shown, for example, in Supplementary Requirement (SR) 13 of American Petroleum Institute (API) Specification 5CT/ISO 11960, “Specification for Casing and Tubing, Petroleum and Natural Gas Industries—Steel Pipes for Use as Casing or Tubing for Wells,” 8th Edition, 2005, seal ring grooves, i.e., “glands,” are machined into one of the sections of the connection among the threads thereof. Seal rings, typically formed of a polytetrafluoroethylene or other fluoropolymer resin which may be filled or unfilled, are mounted in the grooves are compressed as the assembly (makeup) of the threaded connection proceeds. Connections of the type herein involved and the like, as well as seals and gaskets therefor, are shown, for example, in U.S. Pat. Nos. 6,857,668; 6,695,357; 6,669,205; 6,550,822; 5,836,589; 5,823,540; 5,689,871; 5,556,139; 5,263,748; 4,878,285; 4,753,444; 4,708,038; 4,174,846; and 4,127,927.

However, it is known that a seal ring in an underfill condition may have no effective sealing ability. Conversely, a seal ring in an excess overfill condition may develop high, localized stresses that affect the ability of the connection to resist applied loading while in service.

Complicating the matter is that resins such as polytetrafluoroethylene may undergo significant volumetric expansion with increases in temperature. Temperature induced volumetric expansion of the seal ring within a “fixed” void can cause significant, localized stresses in the tubing or casing members, i.e., the tubing or casing, typically called the “pin” in the vernacular, and the coupling, typically called the “box” or “collar” in the vernacular, of the connection.

Moreover, steel, the typical material of construction of the connection members exhibits a property known as “yield stress” wherein steel stressed to a level below its yield stress remains elastic. In such state, stress-induced deformations in the material generally may be recoverable upon the removal of the load. However, when stressed above the yield strength, the material suffers permanent and unrecoverable deformation. In designing structural steel members it therefore is desirable to maintain stress levels below the material yield strength under all applied load conditions. Stress levels above yield may result in excess deformation and potential failure of the structural members.

Assembling the connection imparts stresses into the pin and collar members of the connection and, in so doing, contributes to the stresses which must be resisted by the yield strength of the material. Such makeup stresses thereby reduce the overall service loading capacity of the connection. Similarly, if the seal ring is in an excess overfill condition or upon volumetric expansion contributes additional, localized stresses in the connection as a result of the inherent incompressibility of the seal ring material, the ability of the connection to resist externally-applied mechanical loads can be compromised. Failure modes can be catastrophic and may result in harm to personnel as well as significant damage to the wellbore, casing, tubing, drill rig and other equipment. Conversely, a seal ring in an underfill condition may have no effective sealability and therefore may pose many of the same risks.

In view of the foregoing, it is believed that improvements in methods for the sealing connections between threaded pipes and other tubular sections would be well-received by the oil and gas industry as well as other industries so concerned.

### BROAD STATEMENT OF THE INVENTION

The present invention is directed to a method of sealing connections between threaded pipes and other tubular sections, and more particularly to such a method which includes a precision calculation of the void volume for the seal ring retaining grooves provided in one or both of the sections for the sealing of the connection. The connection may be between, for example, an end of an externally-threaded pipe, shaft, casing, or tubing, or other tubular member, i.e., “pin,” and a mating, internally-threaded coupling, i.e., “box” or “collar,” which may be used for joining the tubular member to another such member.

Research has shown that over-compressed seal rings impart significant stresses in threaded tubular connections. Additionally, volumetric expansion of seal rings at high temperatures, while enhancing sealability in the connection if controlled to within specified limits, can work to “jack” the pin and box members apart if uncontrolled. Indeed, if the internal seal ring grooves formed in a location of the box having a relatively thin cross-section, then internal pressure blocked from relief by the seal ring can cause the box to expand enough to release the matingly-threaded pin which, in turn, can lead to a parting failure in the connection.

This invention herein involved therefor comprehends a design methodology which may be used in conjunction with certain seal ring materials to reduce the potential for such failures in service. Advantageously, such methodology affords a designer a greater ability to consider such aspects of the coupling design as optimum groove size and location and optimum seal ring size and materials, which may be application-specific, in eliminating seal ring underfill and in limiting the amount of overfill to within acceptable limits.

In particular, the method of present invention allows for the precise calculation of the void space defined between the groove in the coupling and mating threads on the pin. Such calculation may take into account the relative deformation of the pin and box which occurs upon the assembly of the connection. With such a precise void volume calculation, the seal ring dimensions can be optimized over a range of tolerance combinations relative to the void volume in the groove after assembly. For example, with the knowledge imparted by the methodology of the present invention, a designer is provided the freedom to locate the seal ring grooves in structurally more robust areas of the connection and otherwise to modify the connection. As a result of such modifications, standard connections may be made more suitable for use in higher pressure and temperature service where such connections otherwise would be unsuitable due to the effects of volumetric expansion of the seal ring at high temperatures such as extrusion or localized high stresses. These and other advantages of the method herein involved will be readily apparent to those skilled in the art based upon the disclosure contained herein.

### BRIEF DESCRIPTION OF THE DRAWINGS

For a fuller understanding of the nature and objects of the invention, reference should be had to the following detailed description taken in connection with the accompanying drawings wherein:

FIG. 1A is an axial, partially-cross-sectional, fragmentary view of the componentry of a representative coupling connection according to the present invention, the coupling including a box having internally-threaded ends, and a pin having externally-threaded ends, at least one which is threadably engageable with one of the ends of the box;

FIG. 1B is an axial, partially-cross-sectional, fragmentary, assembly or “makeup” view of the coupling of FIG. 1A including a pair of seal rings each received in a corresponding internal groove of the box, the view showing one of the ends of the pins being threadably engaged with one of the ends of the box;

FIG. 2A is an axial cross-sectional, fragmentary, somewhat schematic makeup view of showing the details of the engagement of FIG. 1B in a hand-tight condition;

FIG. 2B is a makeup view as in FIG. 2A showing the details of the engagement of FIG. 1B in the minimum power-tight condition, with the maximum power tight condition being depicted in phantom;

FIG. 3A is a 2-dimensional, axial cross-sectional, axisymmetric computer model illustrating the deformed geometry of a simulated makeup of a coupling connection as in FIGS. 1A-B and 2A-B;

FIG. 3B is a model as in FIG. 3A illustrating the deformed geometry of a simulated makeup (assembly) to power-tight as magnified and superimposed over the original geometry of the coupling connection;

FIG. 4 is a model as in FIGS. 3A-B showing superimposed, magnified 2-dimensional views of the void space defined between the seal ring groove of the box and the mating pin thread before and after assembly;

FIG. 5 is an illustration showing the progression in the deformed geometry of a void volume as a helical thread propagates relative to a cylindrical groove to define the void volume;

FIG. 6 is a 3-dimensional solid model of the deformed geometry of the seal ring groove and pin threads as in FIG. 4, with the geometries of the groove and threads being offset to aid in the visualization thereof;

FIG. 7 is a 3-dimensional solid model showing the predicted deformed geometry of the void volume which results from subtracting the 3-dimensional modeled volumes of the groove and threads of FIG. 6;

FIGS. 8-11 are 3-dimensional sections taken 90° intervals of the model of FIG. 7, with the ends of the sections being labeled as one of A-D corresponding to the axial cross-sectional geometry thereat the lines A-D referenced in FIG. 7;

FIG. 12 is a plan view of a representative seal ring as in FIG. 1B; and

FIG. 13 is an axial cross-sectional view of the seal ring of FIG. 12 taken through line 13-13 of FIG. 12.

The drawings will be described further in connection with the following Detailed Description of the Invention.

### DETAILED DESCRIPTION OF THE INVENTION

Certain terminology may be employed in the description to follow for convenience rather than for any limiting purpose. For example, the terms “forward,” “rearward,” “right,” “left,” “upper,” and “lower” designate directions in the drawings to which reference is made, with the terms “inward,” “interior,” “inner,” or “inboard” and “outward,” “exterior,” “outer,” or “outboard” referring, respectively, to directions toward and away from the center of the referenced element, and the terms “radial” or “horizontal” and “axial” or “vertical” referring, respectively, to directions, axes, planes perpendicular and parallel to the central longitudinal axis of the referenced element, and the terms “downstream” and “upstream” referring, respectively, to directions in and opposite that of fluid flow. Terminology of similar import other than the words specifically mentioned above likewise is to be considered as being used for purposes of convenience rather than in any limiting sense.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows.

For the purposes of the discourse to follow, the precepts of the sealing methodology of the invention herein involved are described in connection with a standard pin and box coupling connection used widely in the oil and gas industry. It will be appreciated, however, that the present invention will find applicability to other threaded tubular connections used in the oil and gas industry, such as integral connections wherein each casing or tubing member has a male end and a female end for coupling to a corresponding end of an adjoining member, as well as to connections used in other industries requiring enhanced sealability for liquids or gases. The use thereof in conjunction with such other connections therefore should be considered to be expressly within the scope of the present invention.

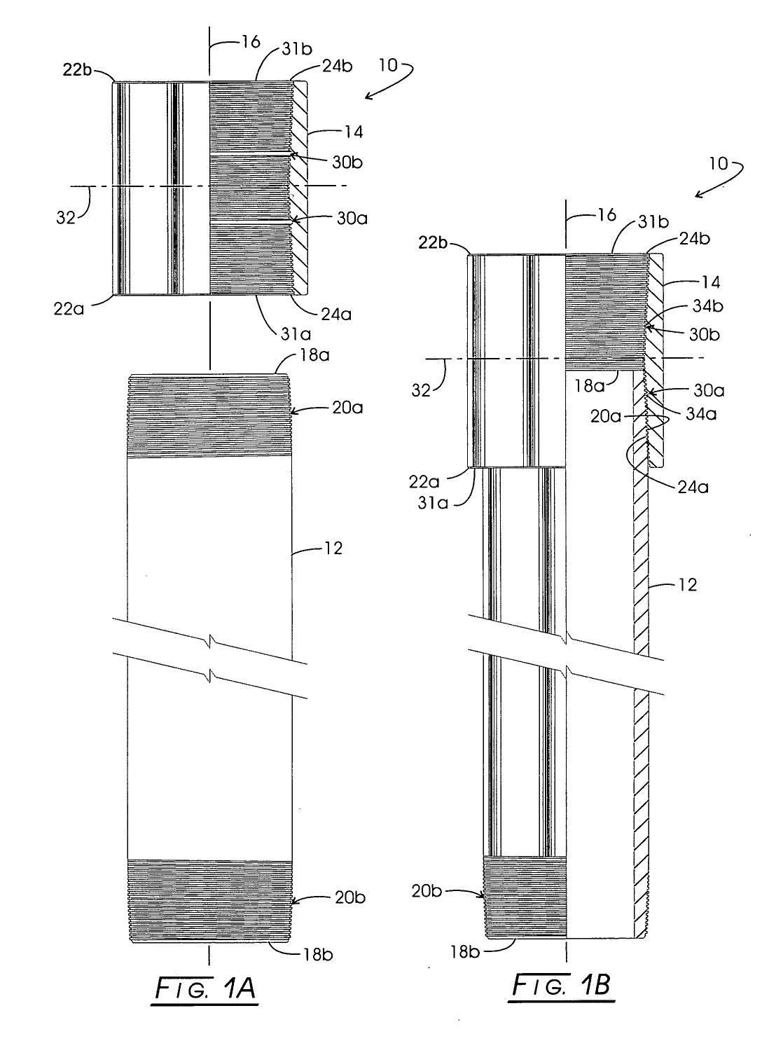

Referring then to the figures wherein corresponding reference numbers are used to designate corresponding elements throughout the several views with equivalent elements being referenced with prime or sequential alphanumeric designations, a representative threaded tubular connection is referenced generally at 10 in the uncoupled view of FIG. 1A and in the coupled view of FIG. 1B. Such connection 10 includes a length or other section of a pipe, casing, tube, riser, or other tubular member or “pin,” 12, and an associated section of a tubular coupling member or “collar,” 14, configured for a coaxial, threaded connection with the pin 12 such as along the common central longitudinal axis thereof referenced at 16.

Pin 12 has male ends, 18a and 18b, which may be generally tapered and externally threaded, such as at 20a and 20b. Collar 14, in turn, has female ends, 22a and 22b, each of which may be tapered and internally threaded, such as at 24a and 24b, to be threadably matingly engageable with a corresponding end 18a or 18b of pin 12 received coaxially therein. In this regard, the inner diameter of the box ends 22a-b is sized to be threadably receivable within the outer diameter of the corresponding pin end 18a or 18b.

The threadform of the pin threads 20a-b and the mating collar threads 24a-b may be API buttress threads or other form which is generally square in cross-section, but alternatively may be API “standard” threads other generally triangular threads or other form. Threadforms of the type herein involved are further described in API Standard RP 5B, “Threading, Gauging, and Thread Inspection of Casing, Tubing, and Line Pipe Threads,” 14^{th} ed., August, 1996, and March 2004 Addendum. Such threadforms, commonly known as interference threads, typically are tapered and advance in the form of a helix around the external circumference of the pin ends 18a-b and internal circumference of the collar ends 22a-b.

Each of the collar ends 22a-b further is formed as having an internal groove, 30a and 30b, machined or otherwise formed therein the corresponding threads 24a-b such as intermediate the terminus, 31a-b, of each of the collar ends 22a-b, and the axial centerline, 32, of the collar 14. Each of the grooves 30a-b may be generally circular in extending circumferentially about the inner diameter of the corresponding collar end 22a-b, and may have a generally square, rectangular, or other cross-sectional shape.

Grooves 30a-b are provided to receive a generally annular seal ring therein, such as the rings 34a and 34b shown in the assembly view of FIG. 1B. Such rings 34a-b, which may have a round, oval, square, rectangular, or other cross-section such as a U-shape, may be formed or a filled or unfilled elastomeric, plastic, or other polymeric material, which material may be filled or unfilled. For chemical resistance, the polymeric material forming the seal rings 34a-b often is specified to be a fluoropolymer, which may be a homopolymer or a fluoropolymer copolymer or blend, mixtures, alloy, or other combination. Representative fluoropolymers include fluorinated ethylene polypropylene (FEP) copolymer, perfluoroalkoxy (PFA) resin, polychlorotrifluoroethylene (PCTFE) copolymer, ethylene-chlorotrifluoroethylene (ECTFE) copolymer, ethylene-tetrafluoroethylene (ETFE) terpolymer, polyvinylidene fluoride (PVDF), polyvinylfluoride (PVF), and, particularly, polytetrafluoroethylene (PTFE). As mentioned the material forming the seal rings 34a-b may be a homo or copolymer, or a combination thereof such as a blend of one or more homopolymers, one or more copolymers, or one or more homopolymers and one or more copolymers. Such materials each additionally may be admixed with other resins, which may be thermoplastic or thermosetting, such as to form an alloy, blend, mixture, or other combination, or a copolymer thereof. Preferred composition, whether filled or unfilled, generally will exhibit sufficient pliability for easy installation into the mounting groove, good extrusion resistance, and robust leak resistance to liquid or gas over a range, both low and high, of service pressures, and at low and high temperature extremes.

Although the material forming the seal rings 34a-b may be unfilled, such material typically is filled with up to about 30% by weight of glass particles for use in liquid and gas pressure service at temperatures up to about 350° F. (175° C.). In accordance with the precepts of the present invention, however, and for higher temperature service, the fluoropolymer or other polymeric material forming the rings 34a-b may be filled with at least about 25% by weight, and typically at least about 50% by weight based on the total weight of the composition of one or more other particulate fillers such as a metal or metal alloy, which may be a steel or a stainless or other corrosion resistant steel (CRES) having an inherently high strength and temperature resistance, or a carbon fiber, silica, ceramic, or mica, or a combination thereof. Higher filler loading levels in general may be used to increase the service temperature of the material forming the rings 34a-b by reducing the volumetric expansion thereof at the higher operating temperatures.

For use in the field, the collar 14 is “bucked” onto one of the ends 18a-b of the pin 12 to form the joint or connection 10 shown in FIG. 1B. Each connection 10 then is run, one at a time, down the wellbore with the pin end 18b oriented downward and the box end 22b oriented upward, and is set in a vertical position. Once set, the second connection 10 is positioned and, the pin 12 thereof is “stabbed” into the collar 14 of the first connection 10. The second connection 10 then is rotated with special equipment called tongs to make up the joint therebetween to what is known as the “power tight” position.

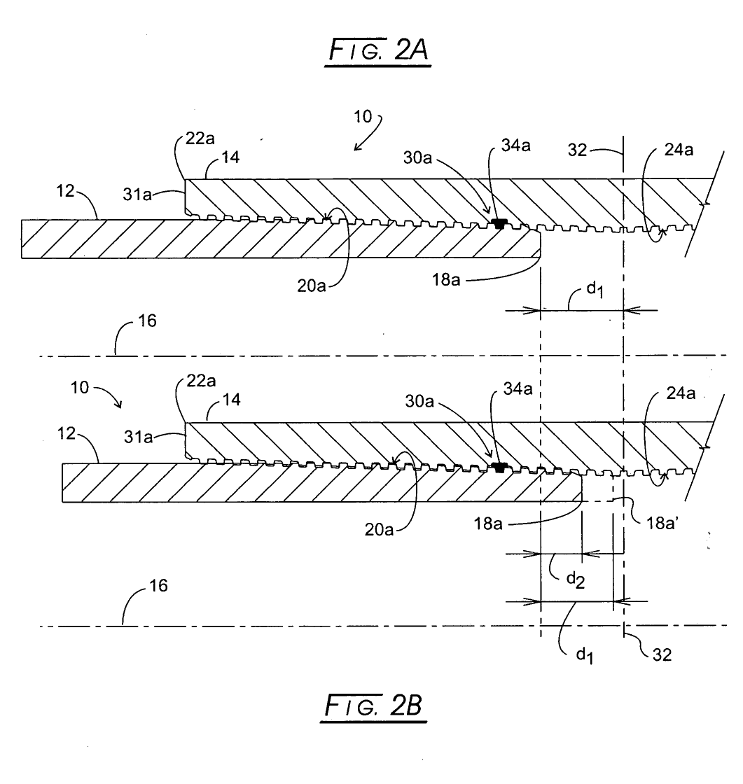

To assist in the visualization of the connection 10, reference may be had to FIGS. 2A and 2B wherein the end 18a of pin 12 is depicted somewhat schematically to be in the form of a truncated external cone which fits into the mating internal cone of the end 22a of the collar 14. However, the outer diametric extent of the external cone of the pin 18a is sized to be marginally larger than the inner diametric extent of the internal cone of the collar end 22a. In this regard, as depicted in FIG. 2A, upon a specific amount of axial advancement of the pin end 18a along axis 16 as the pin 12 is rotated into the collar 14, the respective threads 20a and 24a thereof enmesh completely at a point which defines what is known as the hand-tight position. Additional rotation and corresponding axial advancement of the pin end 18a along the remainder of the axial extent, referenced at d₁, to the centerline 32 of the collar 14 requires the application of torque. The torque required to advance the pin end 18a along the extent d₁ increases steadily until the final, or power-tight position is reached, such as is shown in FIG. 2B, wherein the pin end 18a has been advanced over the axial extent referenced at d₂ to a minimum power-tight condition, and which may be further advanced to a maximum power tight condition as is referenced in phantom at 18a′.

Thus, it may be appreciated that the assembly of the connection 10 forces the larger conical section of the pin end 18a into the marginally smaller mating conical section of the collar end 22a. As a result, as these component parts are mated, they must deflect in opposite directions from one another inasmuch as the two parts cannot occupy the same space. That is, the collar end 22a is forced to expand radially outward, with the pin end 18a being forced to compress radially inwardly. The difference between the outward deflection of the collar end 22a and the inward deflection of the pin end 18a is the interference in the threads 20a and 24a.

In addition to radial deflection, the ends 18a and 22a of the pin 12 and collar 14 are flexed longitudinally during assembly. Specifically, the collar end 22a flexes outwardly and axially elongates, while the pin end 18a flexes inwardly and axially shortens.

Importantly, it also must be understood that the machining of the pin 12 and collar 14 is not perfect inasmuch as the ends 18a and 22a thereof generally are not perfectly round and the wall thicknesses may not be consistent. Indeed, there may be significant variation in each of the components in the connection 10 as to roundness, diameter and wall thickness. The threads 20a and 24a and the groove 30a also may vary, such as in diameter and, in the case of the threads 20a and 24a, in thread height, lead and taper. Additional variability, moreover, may arise from the degree of the pin 12 travel into the collar 14. Specified tolerances placed on certain of the nominal dimensions help to limit theses variations and ensure a more reliable connection under the expected loading conditions. These conditions can include axial tension and compression, internal and external pressures, and bending, or any combination thereof.

Now, considering the these geometric variations in the components of the connection 10, it will be appreciated the void space in the groove 30a which is to be filled with the mass of the seal ring 34a also is subject to significant variation. However, the seal ring 34a can be optimally sized only if the volume of this space can be accurately calculated. Moreover, the seal ring 34a itself has specified dimensions and tolerances which introduces further variation into the calculus. The methodology according to the present invention involves mathematically modeling, such as by way of a finite element analysis (FEA), the geometry of the connection 10. Such model may include the specified tolerance ranges for selected variables such as minimum and maximum thread interferences, makeup positions, and groove locations, as well as the groove width and diameter. Minimum and maximum pin and collar diameters and wall thicknesses, as well as other variables, may be considered in the model.

Each model developed then may be processed using known computational techniques and commercially available computer programs. Such programs are used in many fields to analyze mechanical parts and to relative movements between parts. Output from these programs typically includes deformed shapes, deflections, stresses and strains.

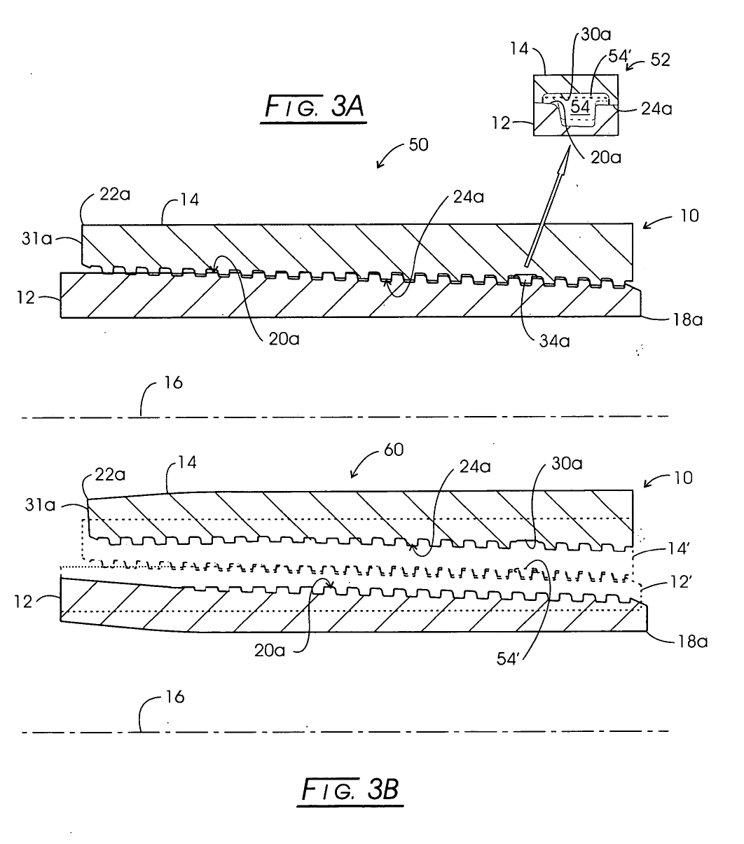

As to the present methodology, the modeling begins by developing and analyzing a 2-dimensional, axisymmetric model which simulates makeup. Relative deflections between the components define an after-assembly deformed shape of the connection 10 such as is depicted at 50 in FIG. 3A. The inset referenced at 52 shows in enhanced detail the void volume, 54, defined by the groove 30a and the threads 20a of the mating pin 12 after assembly. The geometry of the void volume 54 prior to assembly is referenced in phantom at 54′ for comparison.

The model 50 of FIG. 3A reappears at 60 on an enlarged (20×) scale, wherein the relative deflections of the pin 12 and collar 14 appear somewhat exaggerated for a better comparison with the original geometry thereof prior to assembly as shown in phantom at 12′ and 14′. From these FIGS. 3A-B, one can appreciate how the deflection of the pin 12 and collar 14 affects the area of the void volume 54.

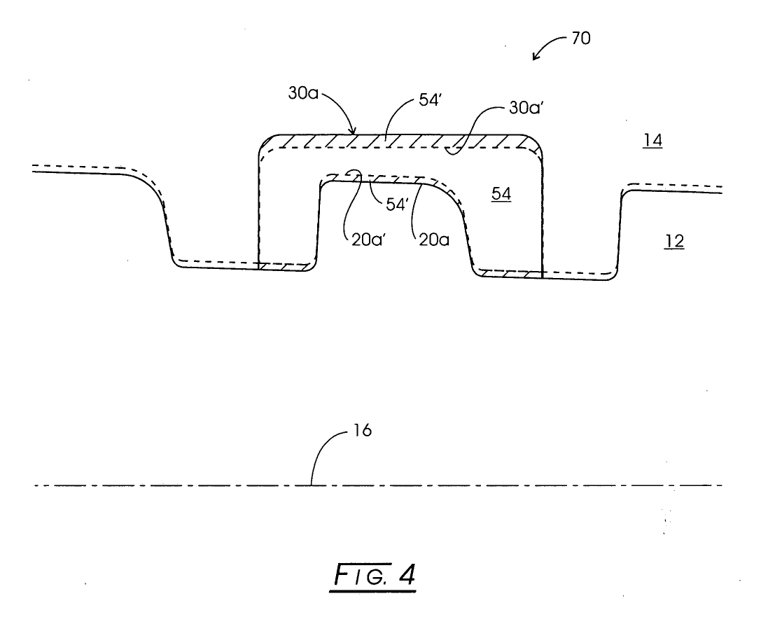

With one or more of the models of FIG. 3A-B thus being developed, FEA then may be are performed on these models, each of which may account for the above-mentioned variations over the minimum and maximum extrema of the tolerance range for one or more of the nominal dimensions of the connection 10. A pictorial representation of the 2-dimensional void space between the seal ring groove 30a and the mating section of the pin thread 20a is depicted at 70 in FIG. 4. Such representation shows the relative orientations of the groove and threads both prior to (30a′ and 20a′) and after (30a and 20a) assembly. The change in the void space defined therebetween also may be visualized by a comparison of the void spaces prior to (54) and after (54′) assembly.

Once the deformed shapes of the seal ring groove 30a and the mating section of the pin threads 20a have been modeled, these 2-dimensional models then can be used to develop a 3-dimensional model of the void volume space by mathematically revolving the 2-dimensional models radially about axis 16 as an axis of revolution to generate a corresponding solid axis of revolution for each of the deformed groove 30a and the mating section of the deformed threads 20a. As to the groove 30a, inasmuch as the groove is circular and radial, the conversion of the 2-dimensional model into a 3-dimensional solid model is straightforward.

The conversion of the mating section of the deformed pin threads 20a is complicated somewhat by the fact that the threads are helical and are machined on the taper of the pin end 18a. For example, API buttress threads have 5 threads per inch on a ¾ inch per foot taper. One complete turn of an API buttress pin member into a matingly threaded collar therefore results in 0.200 inch of axial advancement. To assist in the visualization of how the helical threads 20a propagate relative to the annular groove 30a in defining the void volume 54, reference may be had to FIG. 5 wherein a radial cross-section through a schematic of the connection 10 is depicted at 80. The insets show the progression in the geometry of the groove 54 at 45° intervals as the helical threads 20a progress through the groove 30a with one turn or 360° rotation of the pin 12.

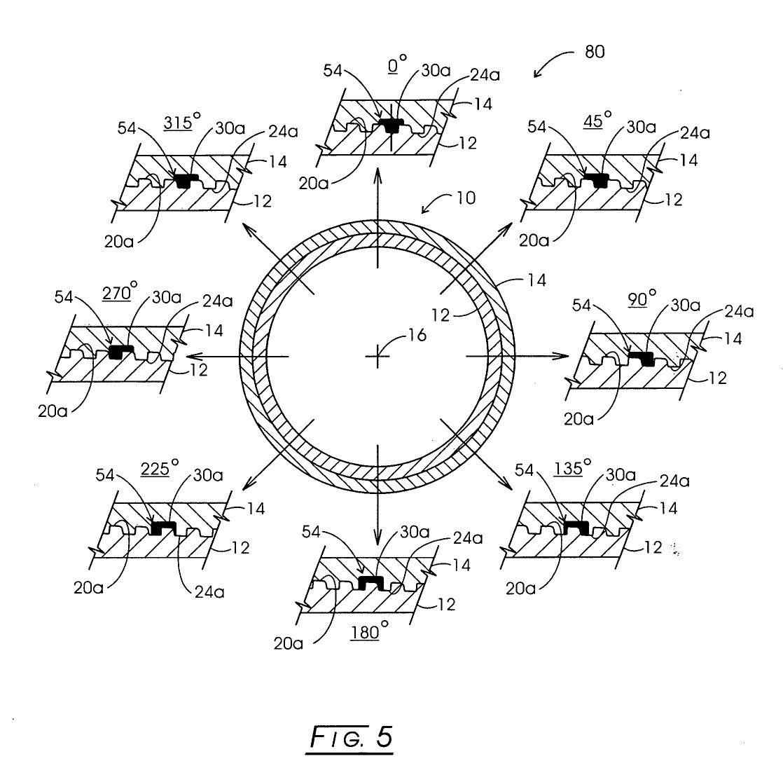

The 2-dimensional deformed thread geometry thus is revolved helically about axis 16 to generate a true 3-dimensional solid model of the threadform geometry. Such geometry is depicted at 90 in FIG. 6, along with the solid model for the groove 30a which is depicted at 92.

Within the connection 10, with groove 30a being aligned over the pin threads 20a, the volumes of the solid models 90 and 92 of FIG. 6 can be subtracted to determine the actual deformed shape of the void volume 54 that must be filled by the seal ring 34a. (FIG. 1B). Such subtraction may be performed using the Boolean operations typically available in commercial computer modeling software.

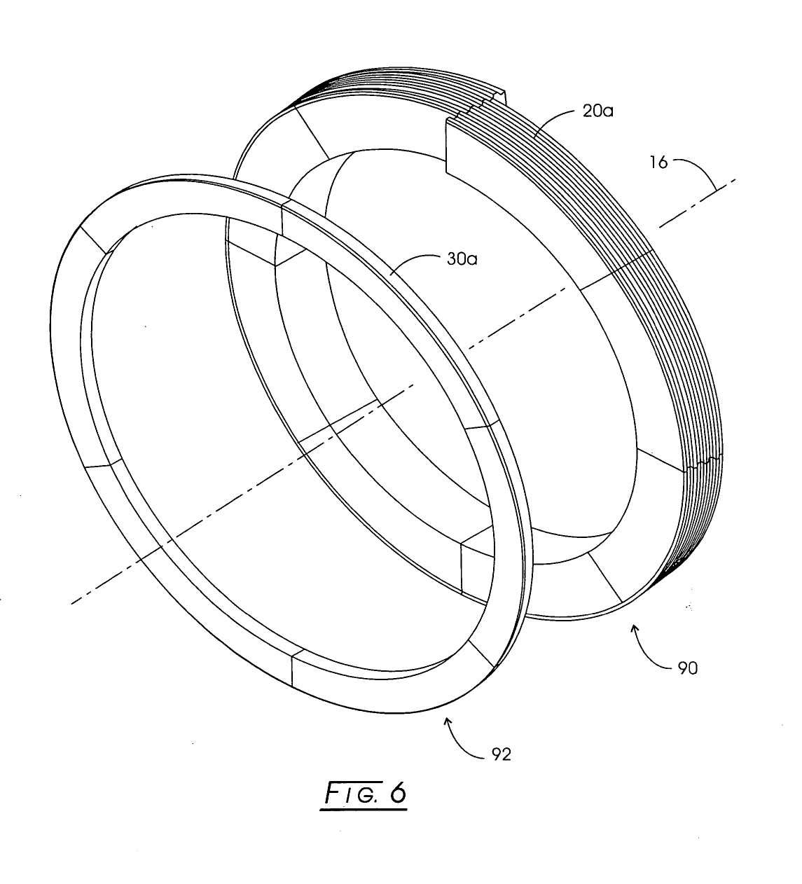

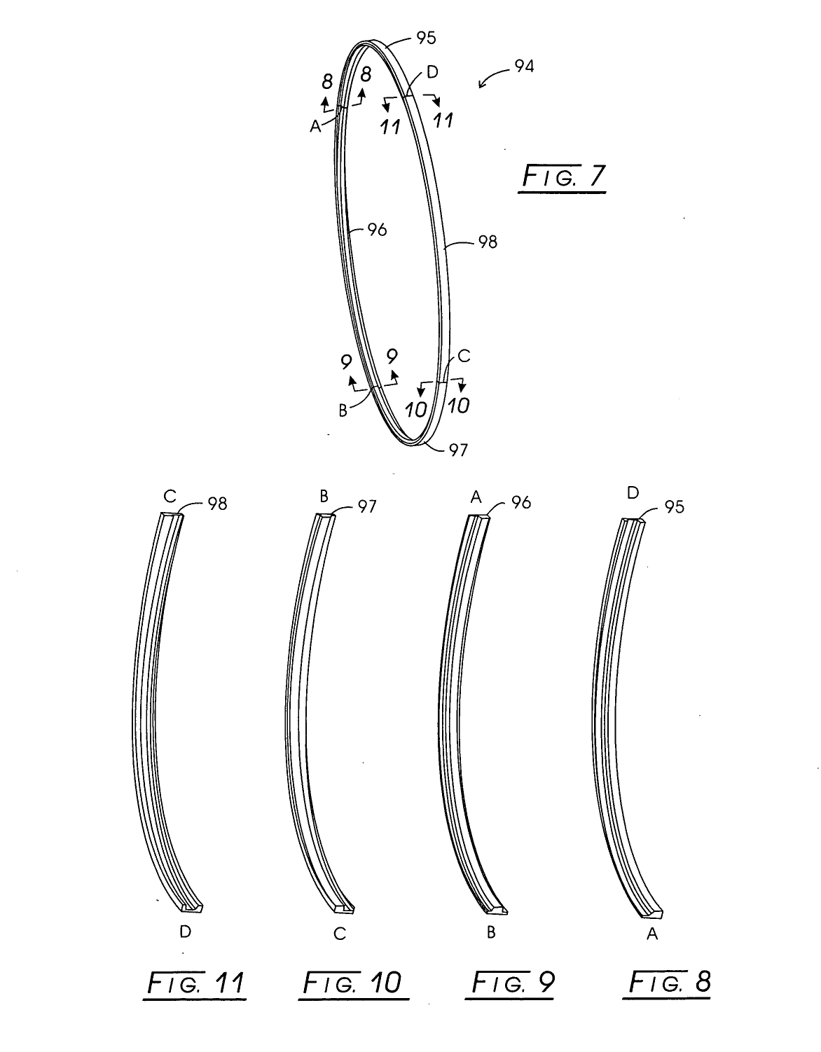

The solid model of the void volume 54 which results after the subtraction is depicted at 94 in FIG. 7, with FIGS. 8-11 showing, respectively, the sections 95-98 thereof taken at 90° intervals. FIG. 7 accurately depicts the void volume in the assembled connection, with such volume representing the gland that must be filled by the “optimized” seal geometry. In FIGS. 8-11, the ends of the sections 95-98 are labeled as one of A-D corresponding to the axial cross-sectional geometry thereat the lines A-D referenced in FIG. 7.

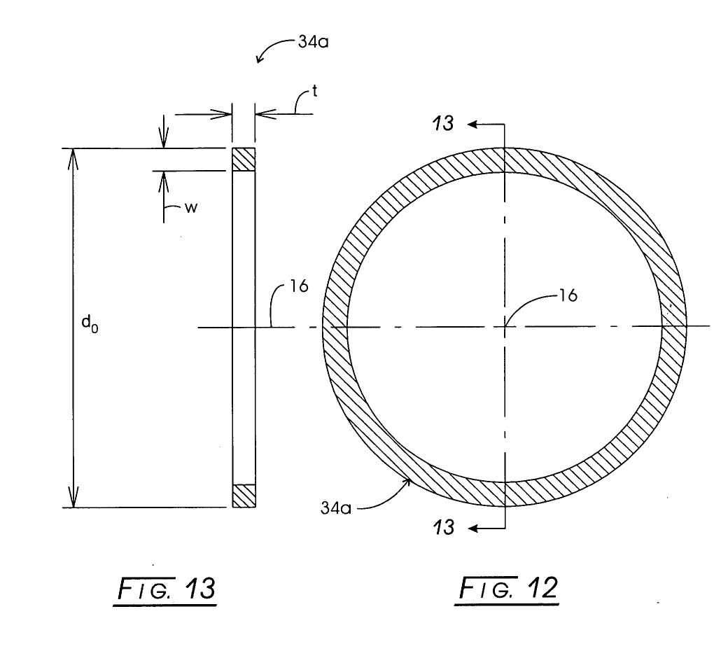

Using the above-describe methodology on standard 9⅝″ OD casing connections, it has been found that the void volume ranges from a minimum of 0.30 cubic inches to a maximum of 0.38 cubic inches in accounting for all material combinations of minimum and maximum tolerance extrema in the connection. Armed with such knowledge of the minimum and maximum limits of the void volume, the designer can readily select, for example, optimal dimensions for the seal rings 34a-b. With reference to FIG. 12 wherein seal ring 34a reappears and, particularly, to FIG. 13 wherein the ring 34a may be seen to have a generally rectangular cross-section, such dimensions can include the ring width, thickness, and outer diameter as referenced, respectively, at “w,” “t,” and “dₒ” in FIG. 13. For mounting within the groove 30a, the seal ring 34a may be sized as having an outer diameter dₒ which is marginally larger than the inside diameter of the groove 30a such that, when mounted in the groove, the ring will be in a state of circumferential compression.

Overall, the designer may wish to limit the minimum seal overfill volume to a minimum of about 2% and a maximum of about 25%. Such limits are believed to be practical in view of the tolerance constraints involved in machining and assembling connections such as used in the oil and gas industry. Of course, tighter overfill tolerances may be possible for connections used in other industries.

Ultimately, the seal ring dimensions and tolerances can be based on the more precise void volume calculations determined using the design and sealing methodology herein involved. Advantageously, the methodology can be used to exercise more control over the overfill by specifying a more precise minimum and maximum range and, as a result, to reducing the potential for localized high stresses in the connection which can develop during assembly and otherwise in service with increases in temperature.

Except as otherwise stated, the materials of construction for the componentry of the connection 10 may be considered conventional for the application involved, and generally may be selected for strength, corrosion or temperature resistance, or other physical or mechanical property, or otherwise for compatibility with the service environment, and/or the fluid being handled. Such fluid may be a liquid such as water, hydraulic oil, a crude oil or other hydrocarbon fuel or other petrochemical, or a process stream. Alternatively, the fluid may be air, such as in a pneumatic application, steam, or another gas.

Although plastics, composites, and other materials may be used where the application permits, the connection componentry in general may be machined, cast, molded, extruded, forged, or otherwise constructed of a metal, which may be same or different for each of the components, and which typically will be a steel but which also may be a copper, brass, stainless steel, titanium, or an aluminum, or an alloy.

Thus, a unique methodology for modeling threaded tubular connections is described such that seal rings therefor may be sized to avoid underfill and excessive overfill conditions, and thereby to improve the sealability of such connections in either normal or high service temperature applications. Such method, moreover, may be used to modify the design of such connections, and in the selection of materials and material formulations for the seal rings used in such connections. Such methodology may be used for industry standard connections or in the design of new connections or the modification of existing connections such as in the addition of a secondary or redundant sealing mechanism therefor. Indeed, use of the methodology herein may allow designers to adapt industry standard connections for use in new applications such as in steam injection and geothermal wells, and to thereby eliminate the need for proprietary or other non-standard connections, and the added costs thereof and for associated special tooling and other accessories, while simplifying logistics for drilling, recovery, or other project involved.

As it is anticipated that certain changes may be made in the present invention without departing from the precepts herein involved, it is intended that all matter contained in the foregoing description shall be interpreted in as illustrative rather than in a limiting sense. All references including any and all priority documents cited herein are expressly incorporated by reference.

What is claimed is:

1. A method of sealing one or more threaded connections aligned relative to a longitudinal central axis between a tubular first member having a generally tapered first end, and a tubular second member having a generally tapered second end, the first end having an externally-threaded first portion, and the second end having an internally-threaded second portion configured to be rotatably threadably engageable along the central axis with the externally-threaded first portion of the first end, one of the first and second portions of the first and second ends having a groove formed therein radially about the central axis configured to receive a seal ring for sealing the connection, the groove defining a void with a mating section of the threaded portion of the other one of the first and second portions, the seal ring being compressed radially into the void by the engagement of the first and second ends, and the geometries of the first and second portions of the first and second ends undergoing one or more deformations upon being rotatably threadably engaged, the method comprising the steps of:
(a) determining the deformed axial cross-sectional geometries of the first and second end portions including the groove and the mating section of the threaded portion;
(b) mathematically revolving the deformed axial cross-sectional geometries of the groove and the mating section of the threaded portion determined in step (a) about the central axis to generate a corresponding solid of revolution for each of the groove and threaded portion;
(c) calculating the volume of the void by subtracting the volume of one of the solids of revolution generated in step (a) from the volume of the other one of the solids of revolution; and
(d) sizing the seal ring to overfill the volume of the void calculated in step (c) by an amount within a specified overfill range.

2. The method of claim 1 wherein:
the first and second ends of the first and second members of the connection each is sized has having one or more nominal dimensions, each of the dimensions being within a corresponding tolerance range having minimum and maximum extrema;
the deformed axial cross-sectional geometries of the groove and the mating section of the threaded portion are determined in step (a) by mathematical modeling of the geometries as a geometry range between the extrema of one or more of the tolerance ranges;
the void volume is calculated in step (c) as a volume range based on the geometry range of step (a); and
the overfill range of step (d) is specified based on the volume range of step (c).

3. The method of claim 2 wherein the seal ring is comprises an admixture of a polymeric material and a particulate filler.

4. The method of claim 3 wherein the polymeric material is selected from the group consisting of fluoropolymer resins and copolymers, and combinations thereof.

5. The method of claim 3 wherein the admixture comprises at least about 25% by weight of the filler.

6. The method of claim 3 wherein the admixture comprises at least about 50% by weight of the filler.

7. The method of claim 3 wherein the particulate filler is selected from the group consisting of metals, metal alloys, carbon fibers, silica, ceramics, or mica, and combinations thereof.
